(19) United States
(12) Patent Application Publication
(10) Pub. No.: US 2011/0187436 A1
(43) Pub. Date: Aug. 4, 2011

(54) INTEGRATION CIRCUIT

(75) Inventor: Hirofumi SAITO, Kanagawa (JP)

(73) Assignee: Renesas Electronics Corporaiton

(21) Appl. No.: 13/017,290

(22) Filed: Jan. 31, 2011

(30) Foreign Application Priority Data
Feb. 2, 2010 (JP) 2010-021470

(51) Int. Cl. G06G 7/18

(52) U.S. Cl. 327/345

(57) ABSTRACT

An integration circuit includes a first differential amplifier that reduces an input offset, which is an offset of a threshold voltage of a transistor that composes a differential pair, using a first clock signal as a clock signal for chopping, a first and a second input terminals that are connected to an inverting input terminal and a noninverting input terminal of the first differential amplifier circuit, and a first capacitance that is connected between the inverting input terminal of the first differential amplifier circuit and an output terminal of the first differential amplifier circuit. The integration circuit changes a frequency of the first clock signal input to the first differential amplifier circuit according to a potential difference between the first and the second input terminals.

### INCORPORATION BY REFERENCE

This application is based upon and claims the benefit of priority from Japanese patent application No. 2010-021470, filed on Feb. 2, 2010, the disclosure of which is incorporated herein in its entirety by reference.

### BACKGROUND

1. Field of the Invention

The present invention relates to an integration circuit.

2. Description of Related Art

There has been an increasing need for higher accuracy (lower offset) of a differential amplifier circuit used for an input circuit along with higher accuracy of control at the time of charging and discharging a battery or the like in a field of a semiconductor integrated circuit. As a related art of such a differential amplifier circuit, there is a technique disclosed in Japanese Unexamined Patent Application Publication No. 2007-74670.

FIG. 13 shows a configuration of an integration circuit 1 disclosed in Japanese Unexamined Patent Application Publication No. 2007-74670. As shown in FIG. 13, the integration circuit 1 includes an integrator 10 and a built-in oscillator 20. The integrator 10 includes a differential amplifier circuit AMP1, resistors R1 and R2, capacitances C1 and C2, input terminals INM and INP, and an output terminal OUT.

The resistor R1 is connected between the input terminal INM and an inverting input terminal VinM of the differential amplifier circuit AMP1. The resistor R2 is connected between the input terminal INP and a noninverting input terminal VinP of the differential amplifier circuit AMP1. The capacitance C1 is connected between an output terminal AMPO and the inverting input terminal VinM of the differential amplifier circuit AMP1. The capacitance C2 is connected between the noninverting input terminal VinP of the differential amplifier circuit AMP1 and a ground terminal GND. The differential amplifier circuit AMP1 inputs clocks CK and CKB from the built-in oscillator 20. The differential amplifier circuit AMP1 inputs signals from external input terminals Iin1 to Iin4.

FIG. 14 shows a configuration of the differential amplifier circuit AMP1. The differential amplifier circuit AMP1 is composed of a folded cascode differential amplifier circuit and a chopping circuit. As shown in FIG. 14, the differential amplifier circuit AMP1 includes a differential stage ST1, a folded cascode stage ST2, and an output stage (output unit) ST3. Further, the differential stage ST1 and the folded cascode stage ST2 compose an input stage differential amplifier. The differential amplifier circuit AMP1 includes PMOS transistors T1 to T8, and T13, NMOS transistors T9 to T12, and T14, and switches SW1 to SW8.

The switches SW1 to SW8 are composed of MOS transistors or the like. The switches SW1, SW4, SW5, and SW7 are opened and closed by the clock CK. The switches SW2, SW3, SW6, and SW8 are opened and closed by an inverting clock CKB, which is an inverting clock of the clock CK. In other words, the switches SW1, SW4, SW5, SW7 operate in reverse to the switches SW2, SW3, SW6 and SW8.

The sources of the PMOS transistors T1, T5, T6, and T13 are connected to a power supply terminal VDD. The sources of the NMOS transistors T11, T12, and T14 are connected to the ground terminal GND. The gate of the PMOS transistor T1 is connected to the terminal Iin4 which supplies a fourth bias, and the drain is connected to the source of the PMOS transistor T2. The gate of the PMOS transistor T2 is connected to the terminal Iin3 which supplies a third bias, and the drain is connected to the sources of the PMOS transistors T3 and T4. The PMOS transistor T2 is cascode-connected to the PMOS transistor T1, and the PMOS transistors T1 and T2 function as a constant current generator.

The input terminal VinP is connected to each end of the switches SW1 and SW2. The inverting input terminal VinM is connected to each end of the switches SW3 and SW4. Each other end of the switches SW1 and SW3 is connected to the gate of the PMOS transistor T4. Each other end of the switches SW2 and SW4 is connected to the gate of the PMOS transistor T3. The drain of the PMOS transistor T3 is connected to the source of the NMOS transistor T10 and the drain of the NMOS transistor T12.

The drain of the PMOS transistor T4 is connected to the source of the NMOS transistor T9 and the drain of the NMOS transistor T11. The gates of the NMOS transistors T11, T12, and T14 are connected to the terminal Iin1 which supplies a first bias, and the NMOS transistor T11, T12, and T14 function as a current generator. The gates of the NMOS transistors 19 and T10 are connected to the terminal Iin2 which supplies a second bias. The PMOS transistors T3 and T4 respectively connect the NMOS transistor T10 and T9, so as to form a differential folded cascode connection.

The drain of the NMOS transistor T9 is connected to each end of the switches SW6 and SW7, and the drain of the PMOS transistor T7. The drain of the NMOS transistor T10 is connected to each end of the switches SW5 and SW8, and the drain of the PMOS transistor T8. The gates of the PMOS transistors T7 and T8 are connected to the terminal Iin3 which supplies the third bias. The source of the PMOS transistor T7 is connected to the drain of the PMOS transistor T5, and the source of the PMOS transistor T8 is connected to the drain of the PMOS transistor T6. The gates of the PMOS transistors T5 and T6 are common, and are connected to the other ends of the switches SW7 and SW8. The PMOS transistors T5 and T6 function as a constant current generator, and the PMOS transistors T7 and T8 will be cascode connections respectively to the PMOS transistors T5 and T6, so as to form a current mirror circuit.

On the other hand, each other end of the switches SW5 and SW6 is connected to the gate of the PMOS transistor T13. The drains of the PMOS transistor T13 and NMOS transistor T14 are common, and are connected to the output terminal AMPO.

Next, an operation of the differential amplifier circuit AMP1 is explained. At this time, the switches SW1, SW4, SW5, and SW7 shall be in a closed (short circuit) state, and the switches SW2, SW3, SW6, and SW8 shall be in an opened condition.

A potential difference between the input terminal VinP and the inverting input terminal VinM is amplified by the PMOS transistors T3 and T4 which compose a differential amplifier, and is input to the gate of the PMOS transistor T13 as a noninverting output signal S10 via the switch SW5 from the drain of the PMOS transistor T8. The PMOS transistor T13 outputs the noninverting output signal from the output terminal AMPO which is a connection point with the NMOS transistor T14 that performs a constant current generator operation, which is to be a load. Note that the switch SW7 is in the closed (short circuit) state, and supplies a predetermined bias to the PMOS transistors T5 and T6.

Next, when the clock signal CK is in an opposite phase, the switches SW1, SW4, SW5, and SW7 are in the opened state, and the switches SW2, SW3, SW6, and SW8 are in the closed (short circuit) state. Then, a similar operation as above is performed and an output signal is output from the output terminal AMPO. That is, the switches SW1, SW4, SW5, and SW7 operate in reverse to the switches SW2, SW3, SW6 and SW8. Further, by switching a noninverting signal and an inverting signal in a time-sharing manner between the input side (the gates of the PMOS transistors T3 and T4) and the output side (the drains of the NMOS transistors T9 and T10), imbalance or the like can be cancelled out. The above explanation is about the operation of the differential amplifier circuit AMP1.

Next, an operation of the integration circuit 1 using the differential amplifier circuit AMP1 is explained with reference to FIGS. 13 and 15. In the integration circuit 1 shown in FIG. 13, an input voltage difference Vin is represented by the formula (1). In this formula, Vinm is a voltage of the inverting input terminal VinM of the integrator circuit 1 (the input terminal INM), and Vinp is a voltage of the noninverting input terminal VinP of the differential amplifier circuit AMP1 (the input terminal INP).

Vin=Vinm−Vinp (1)

A current I1 flowing to the resistor R1 is represented by the following formula (2).

I1=Vin/R1 (2)

The electric charge of the capacitance C1 is represented by the following formula (3).

I1×ΔT=C1×ΔV (3)

In this formula, ΔT is the integration time starting at the time t0, and ΔV is an integration voltage.

If the formula (3) is changed to calculate ΔT, the formula (4) shown below will be obtained.

ΔT=C1×R1×ΔV/Vin (4)

The case of Vinp>Vinm is explained here. By the principle of an imaginary short of the differential amplifier circuit, the potentials of INP and the node N1 will be the same, and the current I1 flowing to the resistor R1, which is connected between the node N1 and INM, flows from the node N1 to INM. The potential by the side of the node N1 of the integration capacitance C1 decreases. On the other hand, the output OUT side of the integration capacitance C1 is charged. Therefore, as shown in FIG. 15, the potential of the output OUT increases (is charged) only by ΔV after ΔT hour.

On the other hand, in the case of Vinp<Vinm, the current flowing to the resistor R1 will be opposite, and the potential of the output OUT of the integrator decreases (is discharged), which is not shown.

An example using specific numerical values is shown below. For example, when C1=100 pF, R1=100 kΩ, ΔV=1 V, and Vin=10 μV, and these values are assigned to the formula (4), ΔT is represented by the following formula (5).

ΔT=100×10⁻¹²×100×10³×1/10×10⁻⁶=1 [s] (5)

From the formula (5), when Vin=10 μV, it is required to be ΔV=1 V in order to increase ΔT=1 s.

The case of considering an input offset voltage Voff is shown in the formula (6).

ΔT=C1×R1×ΔV/(Vin−Voff) (6)

At this time, ΔT when the input offset voltage Voff=1 μV is ΔT=1.11 s. As described so far, the ratio of the input offset voltage Voff to the input voltage difference Vin influences the output value of the integration circuit 1.

As previously mentioned, the devices have been made to reduce the input offset voltage Voff. One of the devices is to make the differential amplifier circuit AMP1 a folded cascode type with a high gain as an inverse number of a gain of the differential amplification circuit is known to be proportional to the input offset voltage. Another device is a technique of chopping that performs an operation to cancel out threshold (Vt) imbalance of the PMOS transistors T3 and T4 of the differential stage inside the differential amplifier circuit.

If the input to the differential stage ST1 of the differential amplifier circuit AMP1 and the output from the folded cascode stage ST2 used as the input to the output stage ST3 are not chopped, as indicated by 103 of FIG. 15, a deviation is accumulated which is generated due to Vt imbalance or the like of the PMOS transistors T3 and T4 of the differential stage ST1. At this time, by the chopping, the output voltage characteristic as indicated by 102 of FIG. 15 can be obtained. The chopping is to alternately switch on and off the switches SW1, SW4, SW5, and SW7 and the switches SW2, SW3, SW6 and SW8 by the forward clock CK and an inverting clock CKB so as to cancel out the Vt imbalance of the PMOS transistors T3 and T4, which are transistors of the differential stage. Then the characteristics will be the ones equivalent to the case of “No Vt offset” as indicated by 101 of FIG. 15, and the Vt offset can be cancelled out.

Note that as another related art, there is a technique as the one disclosed in Japanese Unexamined Patent Application Publication No. 2007-139700 that describes a VF conversion circuit including an integrator having a positive and a negative input terminals, and a first and a second comparators that detect a first detection voltage and a second detection voltage, which is higher than the first detection voltage, from an output from the integrator. The VF conversion circuit outputs an output signal CKOUT with a frequency corresponding to an input voltage. Further, there is a technique as the one disclosed in Japanese Unexamined Patent Application Publication No. 2007-243994 that measures a DC level of the analog output buffer of an inverted polarity in the analog signal processing circuit, which is the offset compensation technique not using chopping, so as to perform offset compensation.

### SUMMARY

At this time, the relative accuracy will surely be reduced in an actual transistor. Therefore, a potential difference is always generated between a drain voltage of the PMOS transistor T7 and a drain voltage of the PMOS transistor T8 in the folded cascode stage ST2 of the differential amplifier circuit AMP1.

If there is a difference in the drain potentials of the PMOS transistors T7 and T8, by the operation of a chopping clock, there is a discrepancy generated in a potential fluctuation supplied to the gate voltage S10 of the MOS transistor T13 when switching from the drain potential of the PMOS transistor T7 to the drain potential of the PMOS transistor T8, and conversely in a potential fluctuation supplied to the gate potential S10 of the PMOS transistor T13 when switching from the drain potential of the PMOS transistor T8 to the drain potential of the PMOS transistor T7.

As a result, a slight error is generated in the AMP0 output potential from an expected potential. Since this error is generated for every chopping clock, the error is multiplied by the number of chopping and accumulated, turns out to be an offset error (hereinafter the accumulation of the error by the chopping clock is referred to as a chopping offset error).

When the chopping clock is constant, in order to obtain the same integration voltage ΔV, the lower the input voltage Vin is, the number of chopping increases. As the result, there is a problem that the lower the input voltage is, the more remarkable offset error deterioration.

For example, if +5 mV is added as a Vt offset to the PMOS transistor T5 of the folded cascode stage ST2 of the differential amplifier circuit AMP1, the output offset will be about 40 mV (60 chopping clocks). Therefore, the output offset per chopping clock will be 667 μV.

FIG. 16 shows a table summarizing the relationship of the integration time Δt and the differential input voltage Vin for obtaining integration voltage ΔV=1V to difference input voltage Vin, for example. In the example of FIG. 16, the integration time Δt for each input voltage Vin is shown at the time of an integration constant (integration resistance 100 kΩ and integration capacitance 100 pF) The integration time Δt0 is a value in the ideal case with no offset, and the integration time Δt1 and Δt2 is a value when the chopping offset errors are added. The calculation is performed where the chopping clock frequency is 20 kHz for Δt1 and 2 kHz for Δt2. The formula can be represented by the following formula (20). Further, the chopping offset error shall be ΔVoff1.

Δt=C×R×(ΔV+ΔVoff1)/Vin (20)

When the input voltage Vin is 10 mV, Δt0 is 1 ms, Δt1 is 1.014 ms, and Δt2 is 1.0014 ms. On the other hand, when the input voltage Vin is 10 μV, Δt0 is 1 s, Δt1 is 14.34 s, and Δt2 is 2.334 s. As mentioned above, the lower the input voltage Vin, the more deviation of the integration time from ideal integration time Δt0 (with no offset). Further, the higher the frequency of the chopping clock, the more deviation of the integration time from the ideal integration time (with no offset).

An exemplary aspect of the present invention is an integration circuit that includes a first differential amplifier that reduces an input offset using a first clock signal as a clock signal for chopping, in which the input offset is an offset of a threshold voltage of a transistor that composes a differential pair, a first and a second input terminals that are connected to an inverting input terminal and a noninverting input terminal of the first differential amplifier circuit, and a first capacitance that is connected between the inverting input terminal of the first differential amplifier circuit and an output terminal of the first differential amplifier circuit. The integration circuit changes a frequency of the first clock signal input to the first differential amplifier circuit according to a potential difference between the first and the second input terminals.

The integration circuit according to the present invention can vary the frequency of the first clock signal, which is input to the first differential amplifier circuit, according to the potential difference between the first and the second input terminals. For example, when the potential difference between the first and the second input terminal is large, the frequency of the first clock signal can be reduced, and when the potential difference is small, the frequency of the first clock signal can be increased. Therefore, it is possible to have an optimal number of chopping clocks by varying the frequency of the first clock signal, which is a clock signal for chopping, according to the potential difference between the first and the second input terminals.

The integration circuit according to the present invention can suppress the deterioration of the offset error due to chopping by the differential amplifier circuit according to the input voltage.

### BRIEF DESCRIPTION OF THE DRAWINGS

The above and other exemplary aspects, advantages and features will be more apparent from the following description of certain exemplary embodiments taken in conjunction with the accompanying drawings, in which:

FIG. 1 shows a configuration of an integration circuit according) a first exemplary embodiment;

FIG. 2 shows a configuration of an integration oscillator for chopping clocks according to the first exemplary embodiment;

FIG. 3 shows a general configuration of a build-in oscillator;

FIG. 4 is a timing chart explaining an operation of the integration oscillator for chopping clocks according to the first exemplary embodiment;

FIG. 5 shows a configuration of an integration circuit according to a second exemplary embodiment;

FIG. 6 shows a configuration of a chopping clock generation unit according to the second exemplary embodiment;

FIG. 7 is a timing chart explaining an operation of a frequency evaluation circuit according to the second exemplary embodiment;

FIG. 8 is a timing chart explaining an operation of a selection circuit according to the second exemplary embodiment;

FIG. 9 shows a configuration of the integration circuit (voltage frequency conversion circuit) according to the second exemplary embodiment;

FIG. 10 shows a configuration of an integration circuit according to a third exemplary embodiment;

FIG. 11 shows a configuration of an integration oscillator for chopping clocks according to the third exemplary embodiment;

FIG. 12 is a timing chart explaining an operation of a voltage detector circuit according to the third exemplary embodiment;

FIG. 13 shows a configuration of an integration circuit according to a related art;

FIG. 14 is a known chopping clock input differential amplifier circuit;

FIG. 15 is an operational waveform of the chopping clock input differential amplifier circuit of FIG. 14; and

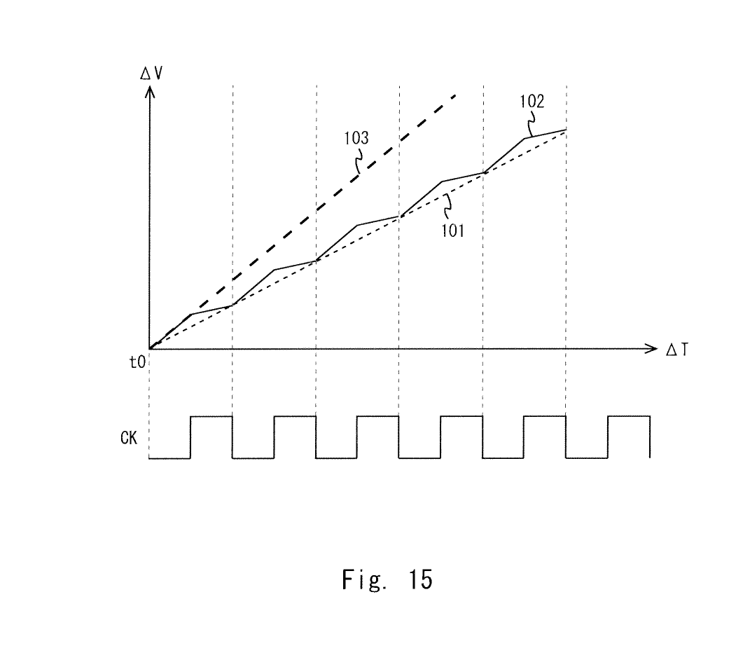

FIG. 16 is a table for explaining the problem of the integration circuit according to the related art.

### DETAILED DESCRIPTION OF THE EXEMPLARY EMBODIMENTS

### First Exemplary Embodiment

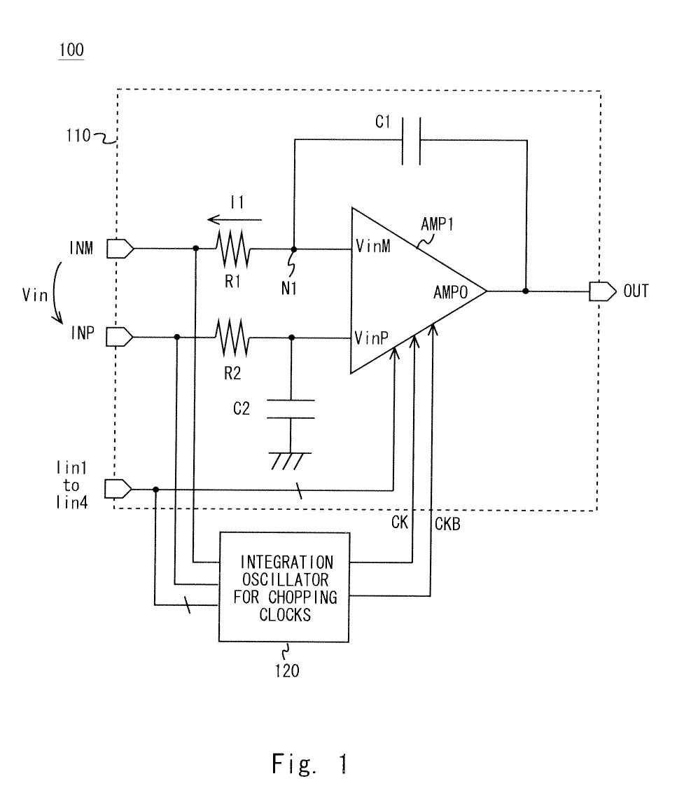

Hereinafter, a specific first exemplary embodiment incorporating the present invention is described in detail with reference to the drawings. FIG. 1 shows a configuration of an integration circuit 100 according to a first exemplary embodiment. As shown in FIG. 1, the integration circuit 100 includes an integrator 110 and an integration oscillator for chopping clocks 120.

The integrator 110 includes a differential amplifier circuit AMP1, resistors R1 and R2, capacitances C1 and C2, input terminals INM and INP, and an output terminal OUT.

The resistor R1 is connected between the input terminal INM and an inverting input terminal. VinM of the differential amplifier circuit AMP1. The resistor R2 is connected between the input terminal INP and a noninverting input terminal VinP of the differential amplifier circuit AMP1. The capacitance C1 is connected between an output terminal AMPO and the inverting input terminal VinM of the differential amplifier circuit AMP1. The capacitance C2 is connected between the noninverting input terminal VinP of the differential amplifier circuit AMP1 and ground terminal GND.

The differential amplifier circuit AMP1 inputs chopping clocks CK and CKB from the integration oscillator for chopping clocks 120. The differential amplifier circuit AMP1 further inputs a bias voltage from external input terminals Iin1 to Iin4.

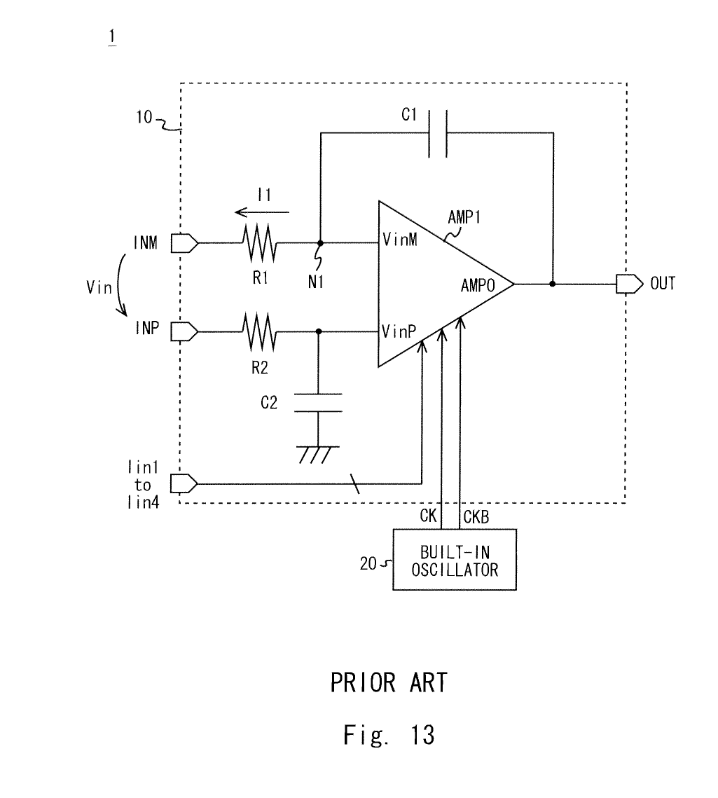

Note that the integrator 110 has basically a similar configuration to the integrator 10 explained in FIG. 13. However, the chopping clocks CK and CKB supplied to the differential amplifier circuit AMP1 are signals output from the integration oscillator for chopping clocks 120, which forms the feature of the present invention. Therefore, the operation of the integrator 110 depends on the chopping clocks CK and CKB which are output from the integration oscillator for chopping clocks 120. However, the basic operation is similar to the one explained with reference to FIG. 13, and the explanation of the integrator 110 is omitted in the first exemplary embodiment. The explanation of the configuration and operation of the integration oscillator for chopping clocks 120 which forms the feature of the present invention is focused below.

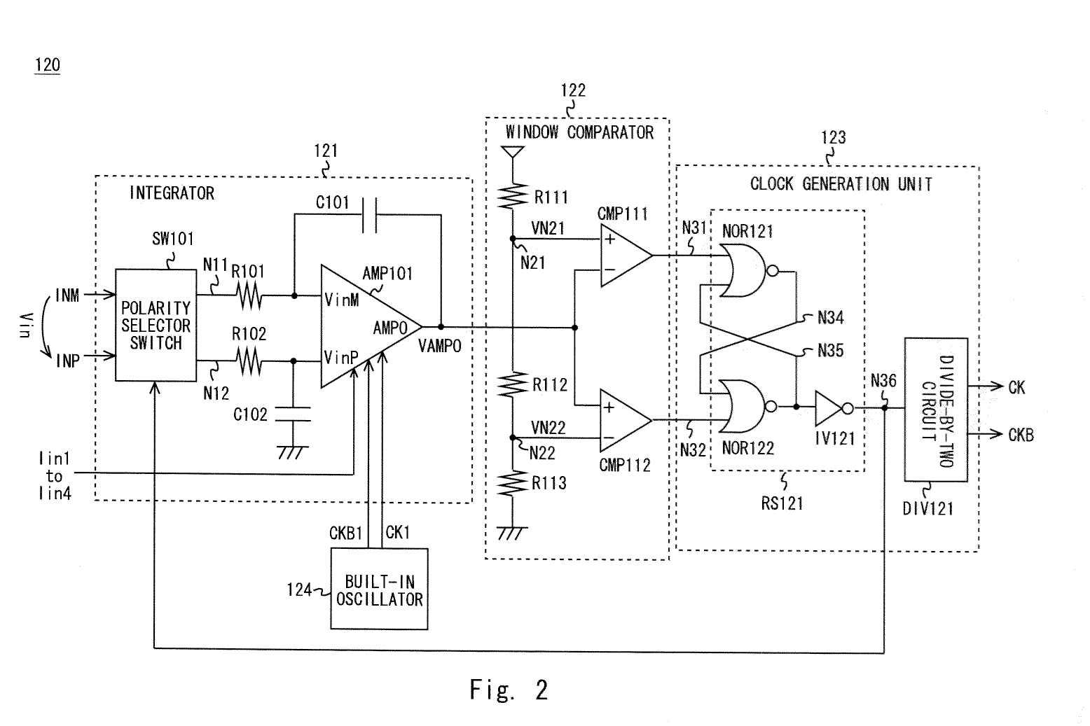

The configuration of the integration oscillator 120 is shown in FIG. 2. As shown in FIG. 2, the integration oscillator for chopping clocks 120 includes an integrator 121, a window comparator 122, a clock generation unit 123, and a built-in oscillator 124.

The integrator 121 includes a differential amplifier circuit AMP101, resistors R101 and R102, capacitances C101 and C102, and a polarity selector switch SW101.

The polarity selector switch SW101 is connected between the input terminals INM and INP, and nodes N11 and N12. The polarity selector switch SW101 switches a connection of the input terminals INM and INP, and the nodes N11 and N12 according to a level of the node N36 described later. For example, in response to a high level signal, the polarity selector switch SW101 connects the input terminal INM and the node N11, and the input terminal INP and the node N12. In response to a low level signal, the polarity selector switch SW101 connects the input terminal INM and node N12, and the input terminal INP and the node N11.

The resistor R101 is connected between the node N11 and the inverting input terminal VinM of the differential amplifier circuit AMP101. The resistor R102 is connected between the node N12 and the noninverting input terminal VinP of the differential amplifier circuit AMP101. The capacitance C101 is connected between the output terminal AMPO and the inverting input terminal VinM of the differential amplifier circuit AMP101. The capacitance C102 is connected between the noninverting input terminal VinP of the differential amplifier circuit AMP101 and the ground terminal GND.

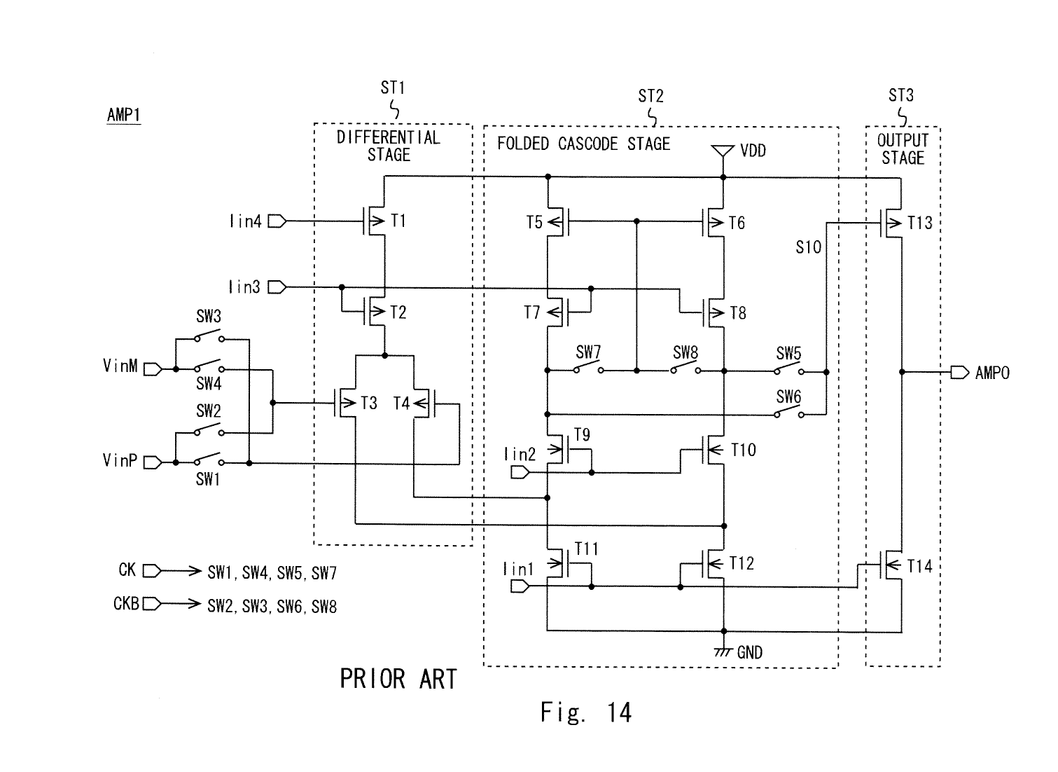

The differential amplifier circuit AMP101 inputs clocks CK1 and CKB1 from the built-in oscillator 124. The differential amplifier circuit AMP101 further inputs the bias voltage from the external input terminals Iin1 to Iin4. Note that as the configuration of the differential amplifier circuit AMP101 is similar to the configuration of the differential amplifier circuit AMP1 explained with reference to FIG. 14, thus the detailed explanation is omitted.

Note that values of the resistors R101 and R102 and the capacitances C101 and C102 are different CR constants from the integrator 110. Therefore, a time constant of the integrator 121 is different from a time constant of the integrator 110.

The window comparator 122 includes resistors R111 to R113, and the comparators CMP111 and CMP112. The resistor R111 is connected between a power supply terminal VDD and a node N21. The resistor R112 is connected between the nodes N21 and N22. The resistor R113 is connected between the node N22 and the ground terminal GND. Therefore, reference voltages VN21 and VN22 are respectively generated in the nodes N21 and N22 as the resistance-divided voltages.

As for the comparator CMP111, a noninverting input terminal is connected to the node N21, and an inverting input terminal is connected to the output terminal AMPO of the differential amplifier circuit AMP101, and an output terminal is connected to a node N31. As for the comparator CMP112, a noninverting input terminal is connected to the output terminal AMPO of the differential amplifier circuit AMP101, an inverting input terminal is connected to the node N22, and an output terminal is connected to a node N32. The voltage of the output terminal AMPO of the differential amplifier circuit AMP101 shall be VAMPO.

The clock generation unit 123 includes an RS latch circuit RS121 and a divide-by-two circuit DIV121. The RS latch circuit RS121 includes NOR circuits NOR121, NOR122, and an inverter circuit IV121.

As for the NOR circuit NOR121, one terminal is connected to the node N31, the other terminal is connected to the node N35, and an output terminal is connected to the node N34. As for the NOR circuit NOR122, one terminal is connected to the node N32, the other terminal is connected to the node N34, and an output terminal is connected to the node N35. As for the inverter circuit IV121, an input terminal is connected to the node N35, and an output terminal is connected to the node N36. The node N36 is an output terminal of the RS latch circuit RS121.

The divide-by-two circuit DIV121 divides by half the frequency of the output signal from the RS latch circuit RS121, and outputs the chopping clock CK (forward signal). The divide-by-two circuit DIV121 also outputs the chopping clock CKB (inverting signal) of an opposite phase to the chopping clock CK.

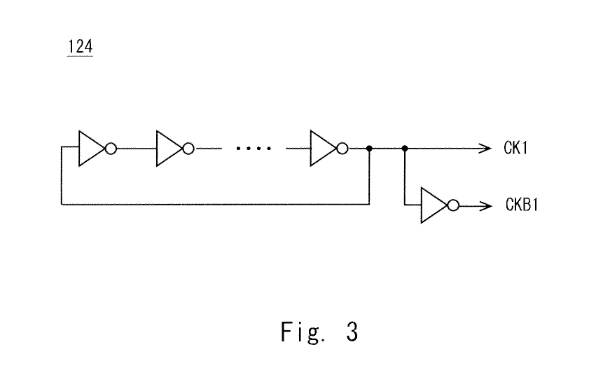

The built-in oscillator 124 is composed of a ring oscillator or the like in which odd-number inverters shown in FIG. 3 are connected in series. Note that the oscillator is not limited to the configuration shown in FIG. 3 but may be realized by other configuration.

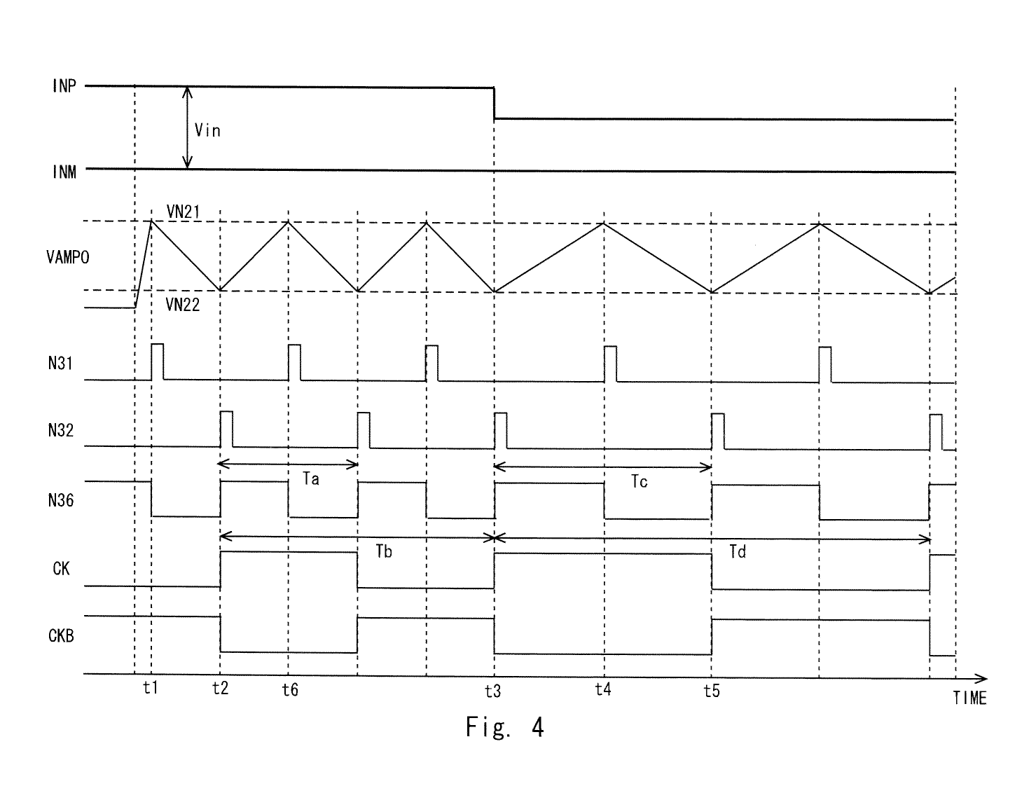

Next, an operation of the integration oscillator for chopping clocks 120 which forms the feature of the present invention according to the first exemplary embodiment is described hereinafter. FIG. 4 shows a chopping operation waveform by the integration type oscillator for chopping clocks 120.

The integrator 121 inputs a signal with a potential difference of Vin (hereinafter referred to as an input voltage Vin) from the input terminals INM and INP. This input voltage Vin is transmitted to the nodes N11 and N12 via the polarity selector switch SW101. Note that the principle of operation of the integration circuit using a differential amplifier (operational amplifier) and a feedback capacitance is well known. Therefore, the explanation of the operation of the integration circuit by the differential amplifier circuit AMP101, the resistors R101 and R102, and the capacitances C101 and C102 is omitted here.

The differential amplifier circuit AMP101 outputs an integration voltage waveform according to the value of the input voltage Vin from the output terminal AMP0. The integration voltage waveform is hereinafter referred to as an integration voltage VAMPO. The integration voltage VAMPO increases, and at the time t1, becomes higher than the reference voltage VN21 input to the noninverting input terminal of the comparator CMP111. Therefore, the output (node N31) from the comparator CMP111 becomes a high level, and a low level signal is output to the node N36 from the RS latch circuit RS121. Accordingly, the connection of the polarity selector switch SW101 is switched, and the polarity of the signal input to the differential amplifier circuit AMP101 is also inverted. Thus the integration voltage VAMPO output from the output terminal AMPO is reduced.

At the time t2, the integration voltage VAMPO becomes lower than the reference voltage VN22, which is input to the inverting input terminal of the comparator CMP112. Therefore, the output (node N32) from the comparator CMP112 becomes a high level, and a high level signal is input to the node N36 from the RS latch circuit RS121. Accordingly, the connection of the polarity selector switch SW101 is switched again, and the polarity of the signal input to the differential amplifier circuit AMP101 is also inverted. Thus the integration voltage VAMPO output from the output terminal AMPO increases again. Afterward, this operation is repeated and a clock signal with a cycle of Ta is output to the node N36.

Then, the divide-by-two circuit DIV121 outputs the chopping clock signal CK, which is the clock signal applied to the node N36 with the frequency divided by half and one cycle of Tb(Tb=2×Ta), and the chopping clock signal CKB, which is in the opposite phase to the chopping clock signal CK.

Next, suppose that the input voltage Vin decreases at the time t3 (potential of the input terminal INP decreases). The basic operations are similar to the one explained for the operation at the time t1 and t2. However, since the input voltage Vin input to the differential amplifier circuit AMP101 decreases, as shown in FIG. 4, a gradient of the waveform of the integration voltage VAMPO after the time t3 becomes less steeper.

Therefore, although the integration voltage VAMPO becomes higher than the reference voltage VN21 input to the noninverting input terminal of the comparator CMP111 at the time t4, the period from the time t3 to t4 is longer than the period from the time t2 t6. This applies to the timing of the time t5 when the integration voltage VAMPO becomes lower than the reference voltage VN22, which is input to the inverting input terminal of the comparator CMP112, and the period from the time t4 to t5 is longer than the period from the time t1 to t2.

That is, if the cycle of the clock signal output from the output terminal (node N36) of the RS latch circuit RS121 after the time t3 is Tc, it can be seen that the cycle Tc is longer than the cycle Ta before the time t3.

Then, the divide-by-two circuit DIV121 outputs the chopping clock signal CK, which is the clock signal applied to the node N36 with the frequency divided by half and one cycle of Td(Td=2×Tc), and the chopping clock signal CKB, which is in the opposite phase to the chopping clock signal CK.

As indicated by the above operation, the integration oscillator for chopping clocks 120 shortens the cycle of the chopping clock signals CK and CKB when the input voltage Vin increases, and extends the cycle of the chopping clock signals CK and CKB when the input voltage Vin decreases. In other words, the integration oscillator for chopping clocks 120 increases the clock frequency of the chopping clock signals CK and CKB if the input voltage Vin increases, and reduces the clock frequency if the input voltage Vin decreases.

As described so far, the integration oscillator for chopping clocks 120 can vary the clock frequency of the chopping clock signals CK and CKB according to the oscillation frequency corresponding to the input voltage Vin. Note that the integration oscillator for chopping clocks 120 can be considered as a voltage frequency conversion circuit that converts the frequency of the output signal according to the input voltage Vin.

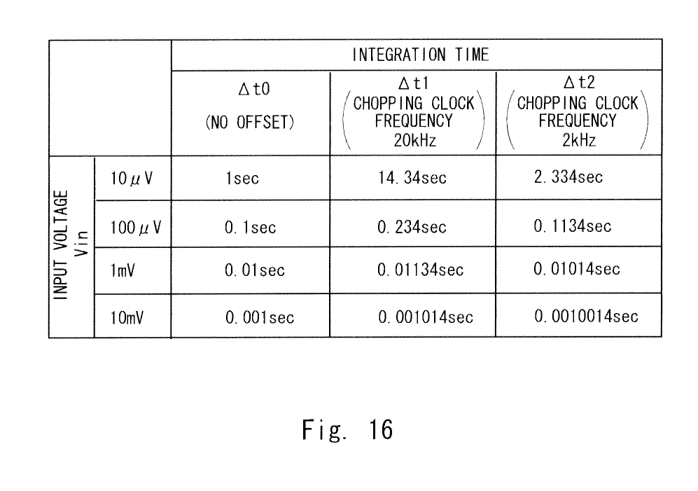

At this time, in the conventional integrator circuit 1 shown in FIG. 13, the frequency of the chopping clock signals CK and CKB input to the differential amplifier circuit AMP1 is fixed. Therefore, as shown in the table of FIG. 16, the lower the input voltage Vin, the more deviation of the integration time generated from the ideal integration time Δt0 (with no offset). Further, the higher the frequency of the chopping clocks, the more deviation is generated from the ideal integration time Δt0.

However, the integrator circuit 100 according to the first exemplary embodiment includes the integration oscillator for chopping clocks 120 that can vary the frequency of the chopping clock, which is input to the differential amplifier circuit AMP1, according to the input voltage Vin. Therefore, if the input voltage Vin is low, the frequency of the chopping clock is reduced to suppress the deviation of the integration time from the ideal integration time Δt0 (with no offset). Conversely, if the input voltage Vin is high, the frequency of the chopping clock can be increased. As described above, by varying the frequency of the chopping clock according to the input voltage Vin, it is possible to have an optimum number of chopping clocks according to the input voltage Vin. This enables suppression of deterioration in the offset error even at the time of inputting a low voltage.

### Second Exemplary Embodiment

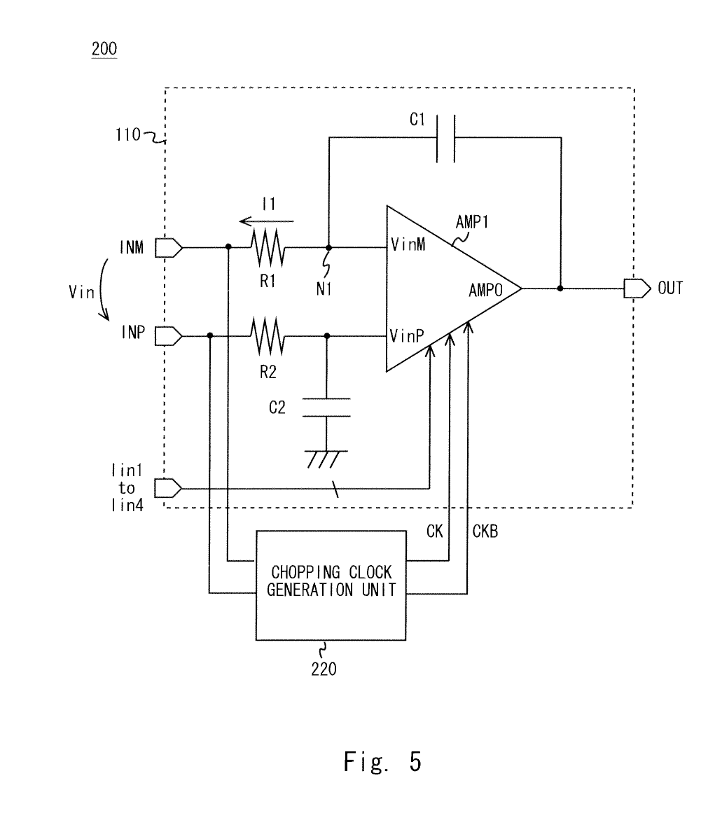

Hereinafter, a specific second exemplary embodiment incorporating the present invention is described in detail with reference to the drawings. FIG. 5 shows a configuration of an integrator circuit 200 according to the second exemplary embodiment. As shown in FIG. 2, the integrator circuit 200 includes an integrator 110 and a chopping clock generation unit 220.

As with the first exemplary embodiment, a basic configuration of the integrator 110 is similar to the integrator 10 explained with reference to FIG. 13. However, the chopping clocks CK and CKB input to the differential amplifier circuit AMP1 are signals output from the integration oscillator for chopping clocks 220, which forms the feature the present invention. Therefore, the operation of the integrator 110 depends on the chopping clocks CK and CKB which are output from the integration oscillator for chopping clocks 220. However, the basic operation is similar to the one explained with reference to FIG. 13, and the explanation of the integrator 110 is omitted also in the second exemplary embodiment. The explanation of the configuration and operation of the chopping clock generation unit 220 which forms the feature of the present invention is focused below.

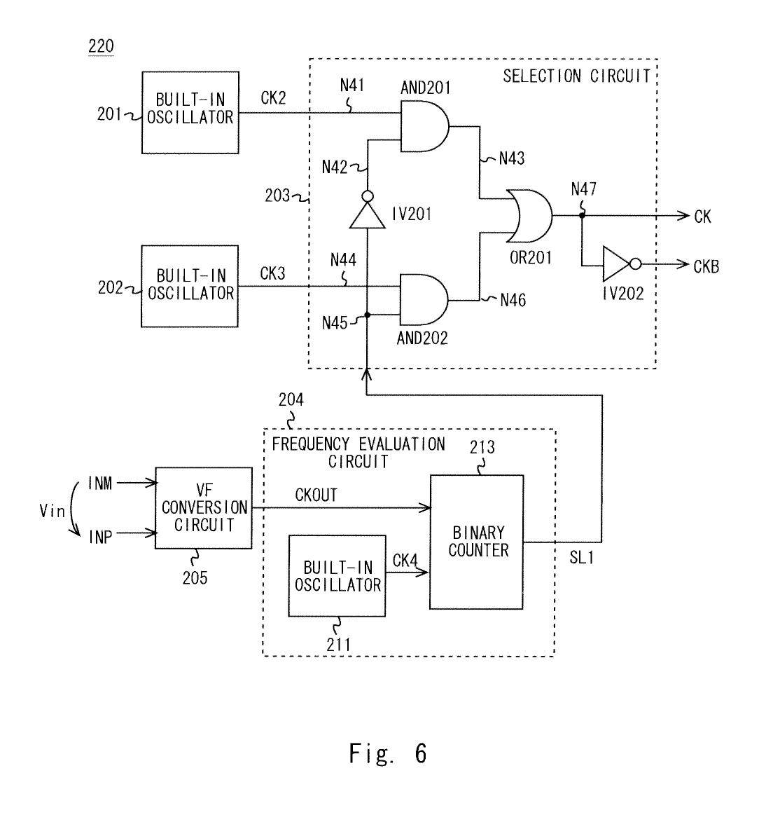

FIG. 6 shows a configuration of the chopping clock generation unit 220. As shown in FIG. 6, the chopping clock generation unit 220 includes built-in oscillators 201 and 202, a selection circuit 203, a frequency evaluation circuit 204, and a voltage frequency conversion circuit 205.

As with the built-in oscillator 214, the built-in oscillators 201 and 202 are composed of a ring oscillator or the like in which odd-number inverters shown in FIG. 3 are connected in series. The built-in oscillator 201 outputs a generated clock signal CK2 to a node N41. The built-in oscillator 202 outputs a generated clock signal CK3 to a node N44. However, the frequencies of the clock signal CK2 output from the built-in oscillators 201 and 202 and CK3 are different. For example, the frequency of the clock signal CK3 will be about 1/10 of the frequency of the clock signal CK2. This value is merely an example, and is not especially limited to this value. Note that the oscillator is not limited to the configuration shown in FIG. 3 but may be realized by other configuration.

The selection circuit 203 includes AND circuits AND201 and AND202, an OR circuit OR201, and inverter circuits IV201 and IV202.

As for the AND circuit AND201, one input terminal is connected to the node N41, the other input terminal is connected to the node N42, and an output terminal is connected to the node N43. As for the AND circuit AND202, one input terminal is connected to the node N44, the other input terminal is connected to the node N45, and an output terminal is connected to the node N46. As for the OR circuit OR201, one input terminal is connected to the node N43, the other input terminal is connected to a node N46, and an output terminal is connected to a node N47. The output signal output from the OR circuit OR 201 to the node N47 will be the chopping clock CK.

As for the inverter circuit IV201, an input terminal is connected to the node N45 and an output terminal is connected to the node N42. As for the inverter circuit IV202, an input terminal is connected to the node N47. The output signal output from the inverter circuit IV202 will be the chopping clock CKB.

The voltage frequency conversion circuit 205 outputs a clock signal CKOUT with a frequency according to the potential difference (input voltage Vin) between the input terminals INM and INP. As an example, the configuration of this voltage frequency conversion circuit 205 may have a similar configuration to the integration oscillator for chopping clocks 120. In this case, a signal output to the node N36 will be the clock signal CKOUT.

The frequency evaluation circuit 204 includes a built-in oscillator 211 and a binary counter 213.

As with the built-in oscillator 124, the built-in oscillator 211 is composed of a ring oscillator or the like in which odd-number inverters shown in FIG. 3 are connected in series. The built-in oscillator 211 outputs a generated clock signal CK4 to the binary counter 213. However, the frequency of the clock signal CK4 shall be sufficiently higher than that of the clock signal CKOUT. Note that the oscillator is not limited to the configuration shown in FIG. 3 but may be realized by other configuration.

When the frequency of the clock signal CKOUT output from the voltage frequency conversion circuit 205 is more than or equal to a predetermined frequency, the binary counter 213 activates a control signal SL1 and outputs it to the node N45. For example, the binary counter 213 counts the clock signal CK4 in the period while the clock signal CKOUT is a high level, and when the number of counts reaches a predetermined value, the binary counter 213 outputs the high level control signal SL1.

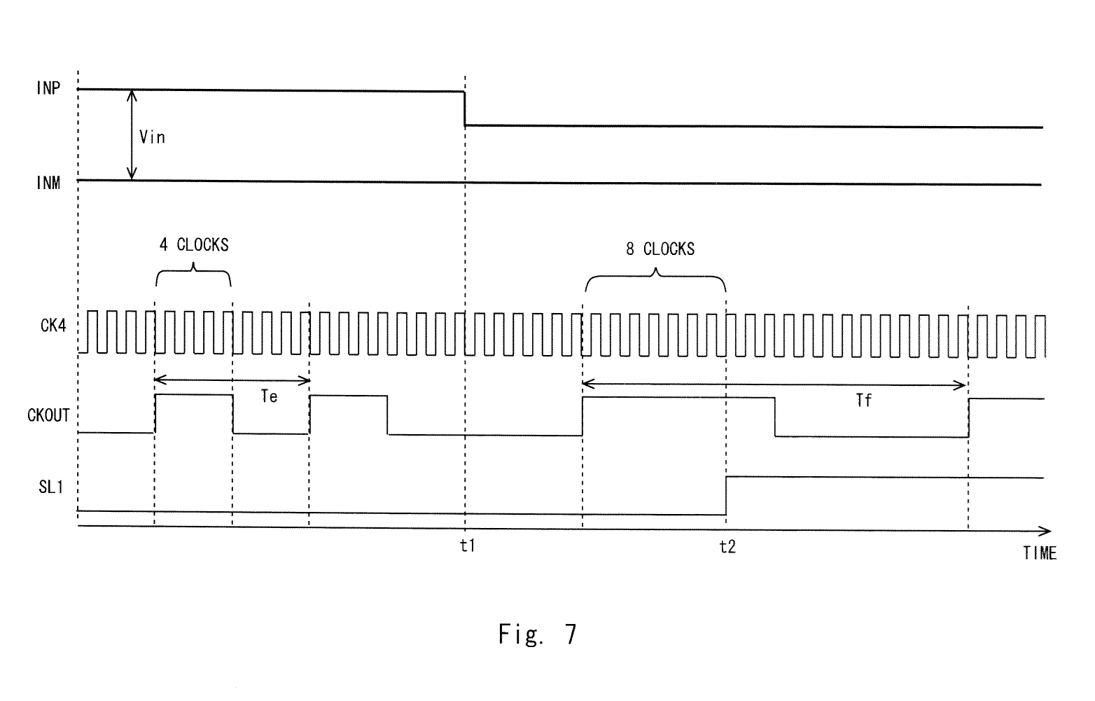

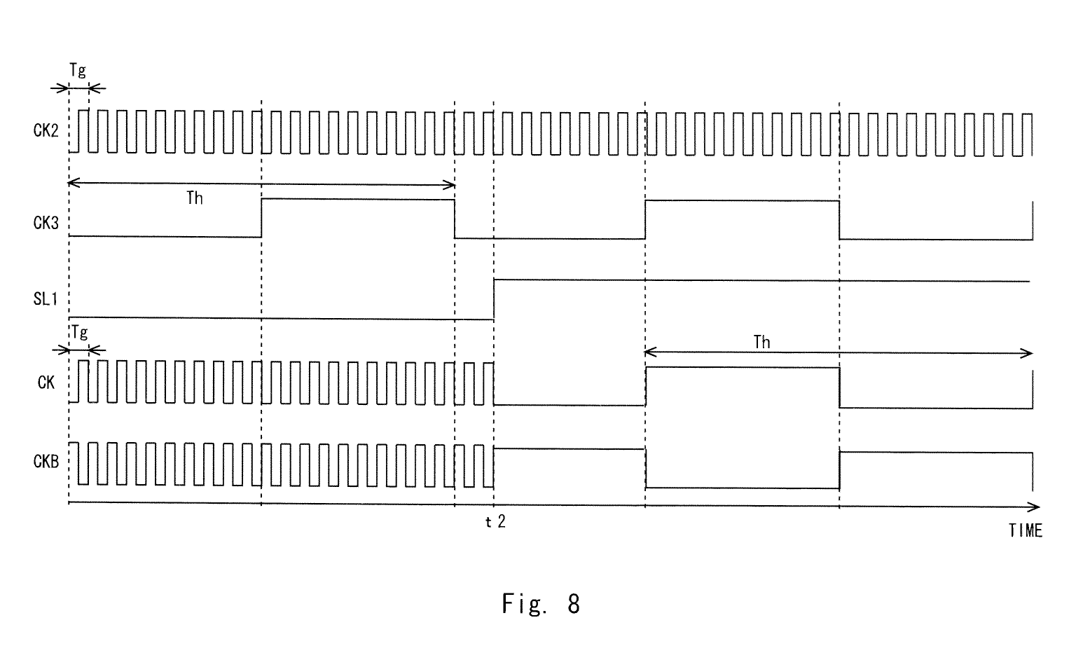

The explanation of the configuration and operation of the chopping clock generation unit 220 which forms the feature of the present invention is focused below. FIGS. 7 and 8 show chopping operation waveforms of the chopping clock generation unit 220.

First, FIG. 7 shows an operation waveform of the frequency evaluation circuit 204. As shown in FIG. 7, up to the time t1, the voltage frequency conversion circuit 205 outputs the clock signal CKOUT with a cycle Te according to the input voltage Vin.

After the time t1, the input voltage Vin decreases, and the frequency of the clock signal CKOUT output from the voltage frequency conversion circuit 205 decreases. That is, the cycle of the clock signal CKOUT after the time t1 changes to a cycle Tf, which is longer than Tc. Then, the binary counter 213 counts the clock signal CK4 during the high level period of the clock signal CKOUT which changed to the cycle Tf. Then, as shown in FIG. 7, for example at the time t2 when the clock signal CK4 is eight or more clocks, the binary counter 213 outputs the control signal SL1 to the node N45.

Next, FIG. 8 shows an operation waveform of the selection circuit 203. However, the time t2 shall be the same time as the time t2 of FIG. 7. Further, the clock signal CK2 from the built-in oscillator 201 shall be 20 kHz and the clock signal CK3 from the built-in oscillator 202 shall be 2 kHz clock signal CK2, for example. As for cycle Tg of the clock signal CK2, 0.05 msec and a cycle Th of clock signal CK3 serve as 0.5 msec in this case.

As shown in FIG. 8, the control signal SL1 is a low level before the time t2. Therefore, a low level is input to the other input terminal (node N45) of the AND circuit AND202, and an output from the AND circuit AND202 is fixed to the low level. Accordingly, a signal level of the node N46 is fixed to the low level.

On the other hand, a high level is input to the other input terminal (node N42) of the AND circuit AND201, and a signal according to the output clock signal CK2 from the built-in oscillator 201 is output to the node N43. In this case, the AND circuit AND201 will be a through circuit and the output clock signal CK2 from the built-in oscillator 201 is transmitted to the node N43.

The OR circuit OR201 performs an add operation to the signals applied to the nodes N43 and N46 and outputs it to the node N47. As the node N46 is fixed to the low level, the OR circuit OR201 outputs the signal from the output terminal (node N43) of the AND circuit AND201.

As a result, if the control signal SL1 is a low level, the selection circuit 203 selects the output clock signal CK2 from the built-in oscillator 201, and outputs it as CK.

After the time t2, the control signal SL1 becomes a high level. Therefore, a low level is input to the other input terminal (node N42) of the AND circuit AND201, and the output of the AND circuit AND201 is fixed to the low level.

On the other hand, a high level is input to the other input terminal (node N45) of the AND circuit AND202, and a signal according to the output clock signal CK3 from the built-in oscillator 202 is output to the node N46. In this case, the AND circuit AND202 will be a through circuit, and the output clock signal CK3 from the built-in oscillator 202 is transmitted to the node N46.

The OR circuit OR201 performs an add operation to the signal applied to the nodes N43 and N46, and outputs it to the node N47. As the node N43 is fixed to a low level, the OR circuit OR201 outputs a signal from the output terminal (node N46) of the AND circuit AND202.

As a result, if the control signal SL1 is a high level, the selection circuit 203 selects the output clock signal CK3 from the built-in oscillator 202, and outputs it as CK.

From the explanation of the operation of FIGS. 7 and 8, if the input voltage Vin is high, the control signal SL1 will be a low level, and the selection circuit 203 selects and outputs the output clock signal CK2 from the built-in oscillator 201 with a high frequency. This output clock signal CK2 is output from the chopping clock generation unit 220 as the chopping clock signal CK. Note that the output clock signal CK2 inverted by the inverter circuit IV202 is output from the chopping clock generation unit 220 as the chopping clock signal CKB.

Then, if the input voltage Vin decreases, the control signal SL1 will be a high level, and the selection circuit 203 selects and outputs the output clock signal CK3 from the built-in oscillator 202 with a low frequency. This output clock signal CK3 is output from the chopping clock generation unit 220 as the chopping clock signal CK. Note that the output clock signal CK3 inverted by the inverter circuit IV202 is output from the chopping clock generation unit 220 as the chopping clock signal CKB.

As mentioned above, the integrator circuit 200 according to the second exemplary embodiment includes the chopping clock generation unit 220 that can vary the chopping clock frequency, which is input to the differential amplifier circuit AMP1, according to the input voltage Vin. Therefore, as with the first exemplary embodiment, the integration circuit 200 according to the second exemplary embodiment reduces the frequency of the chopping clock if the input voltage Vin is low to suppress the deviation of the integration time from the ideal integration time Δt0 (with no offset). Conversely, if the input voltage Vin is high, the frequency of the chopping clock can be increased. As described above, by varying the frequency of the chopping clock according to the input voltage Vin, it is possible to have an optimum number of chopping clocks according to the input voltage Vin. This enables suppression of deterioration in the offset error even at the time of inputting a low voltage.

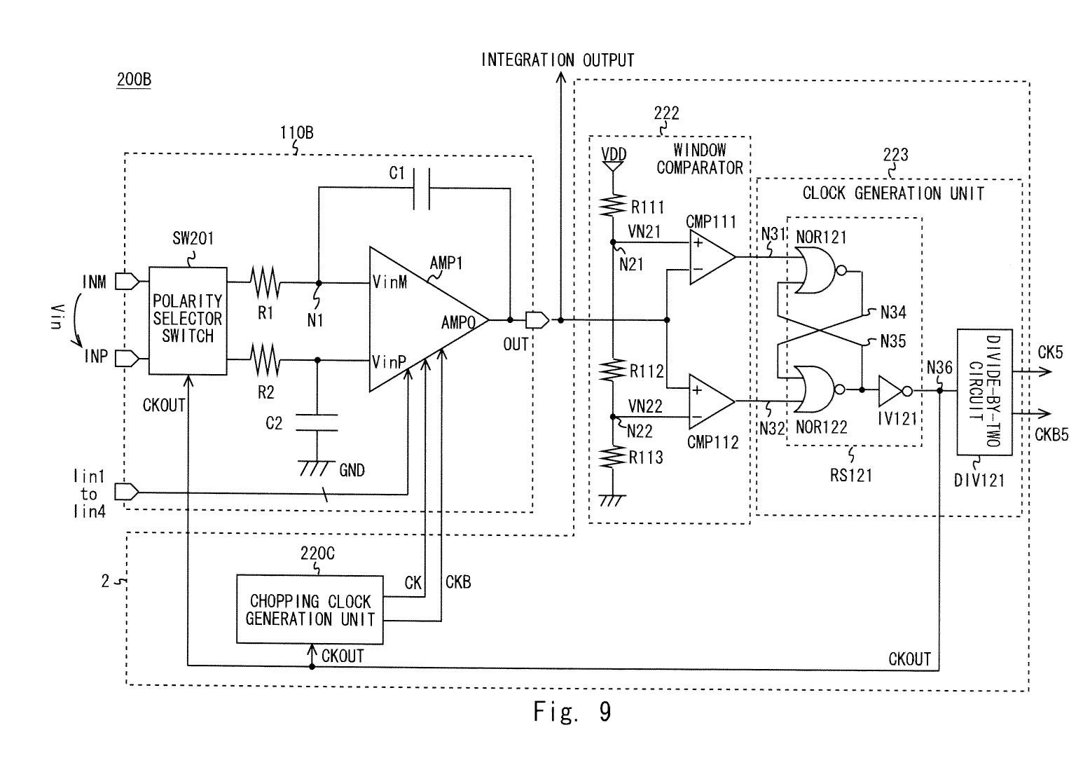

As another example, the integration circuit according to the second exemplary embodiment may have the configuration of an integration circuit 200B shown in FIG. 9. The integrator circuit 200B includes an integrator 11013 and a chopping clock generation unit 2.

The basic configuration of the integrator 110B is same as the integrator 110, but further includes a polarity selector switch SW201 between the input terminals INM and INP, and the resistors R1 and R2. The polarity selector switch SW201 switches a connection of the input terminals INM and INP, and the resistors R1 and R2 in response to the clock signal CKOUT. For example, in response to the high level clock signal CKOUT, the polarity selector switch SW201 connects the input terminal INM and the resistor R1, and the input terminal INP and the resistor R2. In response to the low level clock signal CKOUT, the polarity selector switch SW201 connects the input terminal INM and the resistor R2, and the input terminal INP and the resistor R1.

The chopping clock generation unit 2 includes a window comparator 222, a clock generation unit 223, and a chopping clock generation unit 220C.

The window comparator 222 has a similar configuration as the window comparator 122 according to the first exemplary embodiment, except that the integration voltage from the integrator 110B is input to the inverting input terminal of the comparator CMP111 and the noninverting input terminal of the comparator CMP112. Accordingly, since the operation is similar to that of the window comparator 122, the explanation is omitted here.

Moreover, the clock generation unit 223 has a similar configuration and performs a similar operation to the clock generation unit 123 according to the first exemplary embodiment, the explanation is omitted here. However, the signal output from the RS latch circuit RS121 of the clock generation unit 223 to the node N36 is CKOUT.

The clock signal CKout generated by the chopping clock generation unit 220C is input to the chopping clock generation unit 220C. The configuration of the chopping clock generation unit 220C is same as that of the chopping clock generation unit 220 without the voltage frequency conversion circuit 205. That is, the chopping clock generation unit 220C inputs the clock signal CKOUT, which is input to the frequency evaluation circuit 204, from the node N36 of the clock generation unit 223 instead of the voltage frequency conversion circuit 205. Afterward, the operation which was explained with reference to FIG. 7 is performed according to input clock signal CKOUT.

With this configuration, the integration circuit 200B composed of the integrator 110B, the window comparator 222, the clock generation unit 223, and the chopping clock generation unit 220C basically performs a similar operation to the integration oscillator for chopping clocks 120 according to the first exemplary embodiment. That is, as with the integration oscillator for chopping clocks 120 according to the first exemplary embodiment, the frequency of the clock signal CKOUT output to the node N36 is changed according to the input voltage Vin, which is a potential difference between the input terminals INP and INM. Accordingly, it can be said that the integration circuit 200B composes the voltage frequency conversion circuit. Then, the clock signal CKOUT input to the chopping clock generation unit 220C is generated by the voltage frequency conversion circuit that uses the integrator circuit 200B. Thus, the chopping clock generation unit 2 can eliminate the voltage frequency conversion circuit 205 included in the chopping clock generation unit 220 of FIG. 6.

In other words, even if the voltage frequency conversion circuit using the integrator circuit 200B is used instead of the eliminated voltage frequency conversion circuit 205, the integrator circuit 2008 can reduce the circuit size for the voltage frequency conversion circuit 205 as compared to the integrator circuit 200.

Note that the clock generation unit 223 inputs the clock signal CKOUT to the divide-by-two circuit DIV121, divides the frequency of the clock signal CKOUT, and generates and outputs a clock signal CKB5, which is an inverting signal of a clock signal CK5. These clock signals CK5 and CKB5 can be used as output signals from the voltage frequency conversion circuit.

### Third Exemplary Embodiment

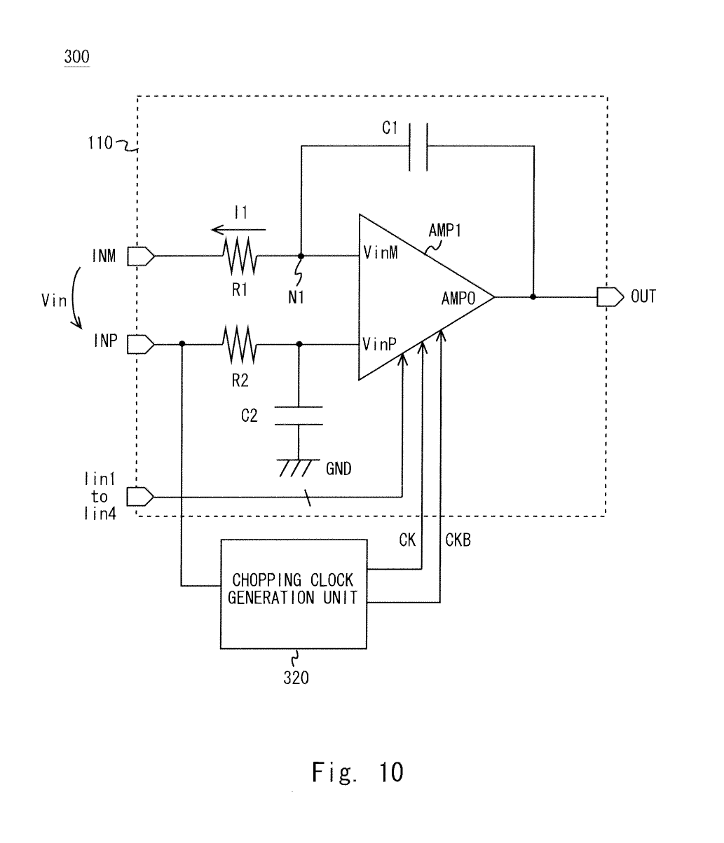

Hereinafter, a specific third exemplary embodiment incorporating the present invention is explained in detail with reference to the drawings. FIG. 10 shows a configuration of an integrator circuit 300 according to the third exemplary embodiment. As shown in FIG. 10, the integrator circuit 300 includes an integrator 110 and a chopping clock generation unit 320.

As with the first exemplary embodiment, a basic configuration of the integrator 110 is similar to the integrator 10 explained with reference to FIG. 13. However, the chopping clocks CK and CKB input to the differential amplifier circuit AMP1 are signals output from the integration oscillator for chopping clocks 320, which forms the feature the present invention. Therefore, the operation of the integrator 110 depends on the chopping clocks CK and CKB which are output from the chopping clock generation unit 320. However, the basic operation is similar to the one explained with reference to FIG. 13, and the explanation of the integrator 110 is omitted also in the third exemplary embodiment. The explanation of the configuration and operation of the chopping clock generation unit 320 which forms the feature of the present invention is focused here.

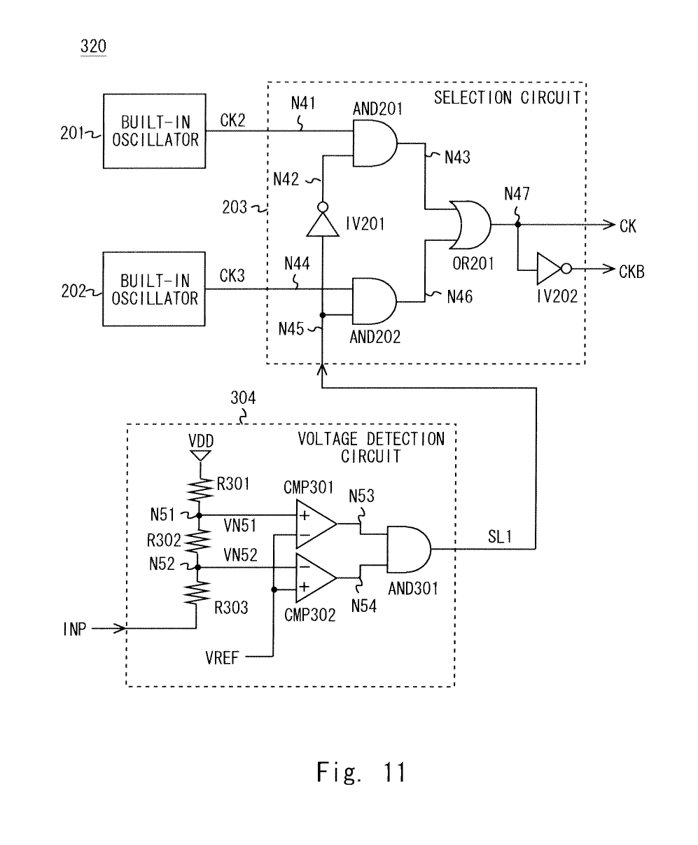

FIG. 11 shows a configuration of the chopping clock generation unit 320. As shown in FIG. 11, the chopping clock generation unit 320 includes built-in oscillators 201 and 202, a selection circuit 203, and a voltage detection circuit 304. The components denoted by the same numerals as FIG. 11 are the same or similar configurations as FIG. 6. A difference from the second exemplary embodiment is that the frequency evaluation circuit 204 is replaced with the voltage detection circuit 304. Therefore, the explanation of the difference from the second exemplary embodiment is focused below, and the explanation of the same components is omitted.

The voltage detection circuit 304 includes resistors 8301 to R303, comparators CMP301 and CMP302, and an AND circuit AND301.

The resistor R301 is connected between a power supply terminal VDD and a node N51. The resistor R302 is connected between the node N51 and a node N52. The resistor R303 is connected between the node N52 and an input terminal INP. Accordingly, a voltage, which is a potential difference between the voltages applied to the power supply voltage VDD and the input terminal INP divided by the resistors R301 to 303, is generated in the nodes N51 and N52.

As for the comparator CMP301, a noninverting input terminal is connected to the node N51 and an output terminal is connected to a node N53. Then, a reference voltage VREF is applied to the inverting input terminal of the comparator CMP301.

As for the comparator CMP302, an inverting input terminal is connected to the node N52 and an output terminal is connected to a node N54. Then, the reference voltage VREF is applied to the noninverting input terminal of the comparator CMP302.

As for the AND circuit AND301, one input terminal is connected to the node N53, and the other input terminal is connected to the node N54. The AND circuit AND301 performs a multiplication operation to the signal applied to the nodes N53 and N54, and outputs a calculation result to the node N45 as the control signal SL1.

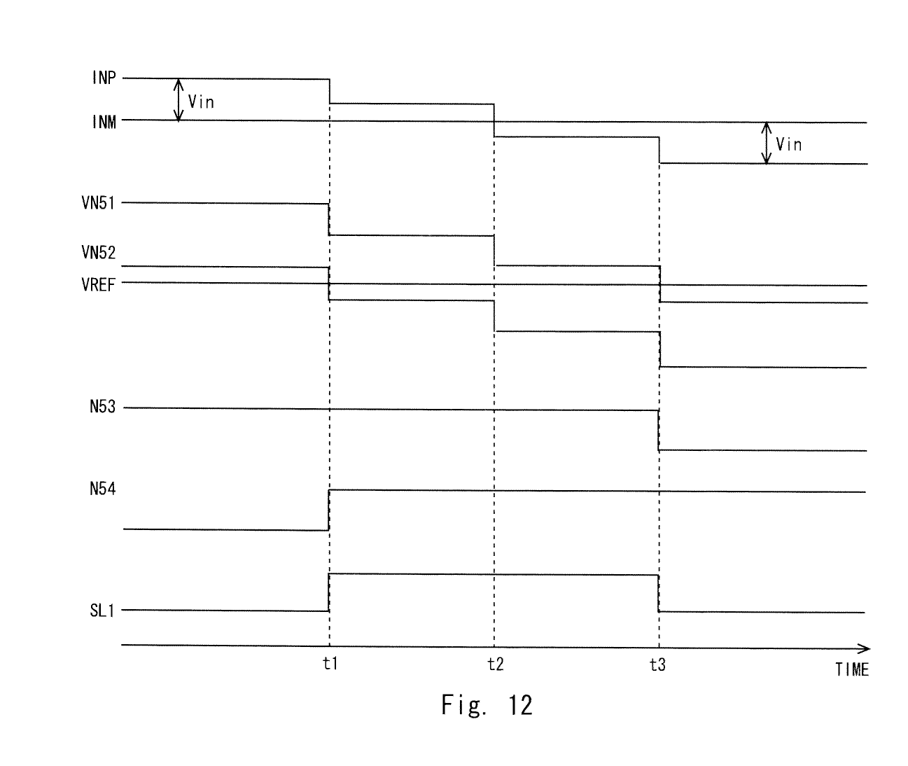

Next, an operation of the chopping clock generation unit 320 which forms the feature of the present invention according to the third exemplary embodiment is explained with reference to FIG. 12. However, since the operation of the selection circuit 203 is similar to the one explained in the second exemplary embodiment, the explanation is omitted here and only the operation of the voltage detection circuit 304 is explained. Further, in order to simplify the explanation, the voltage of the input terminal INM shall be constant.

First, as shown in FIG. 12, the voltage of the input terminal INP shall be higher than the voltage of the input terminal INM before the time t1. If both of the voltage of the node N51 (hereinafter referred to as VN51) and the voltage of the node N52 (hereinafter referred to as VN52) are higher than the reference voltage VREF, the comparator CMP301 outputs a high level and the comparator CMP302 outputs a low level. Therefore, the AND circuit AND301 outputs a low level as the control signal SL1.

Then, when the voltage of the input terminal INP is reduced at the time t1, meaning that when the input voltage Vin is reduced, VN51 and VN52 are also reduced. Then, if VN52 becomes lower than VREF, the comparator CMP302 will output a high level and the AND circuit AND301 will output a high level as the control signal SL1.

A case is considered hereinafter in which the voltage of the input terminal INP further decreases to be lower than the voltage of the input terminal INM. At the time t2, the voltage of the input terminal INP decreases to be lower than the voltage of the input terminal INM. Then, VN51 and VN52 are also reduced. However, if VN51 is not lower than VREF, the comparators CMP301 and CMP302 output a high level. Therefore, the AND circuit AND301 outputs a high level as the control signal SL1 in a similar way as after the time t1.

Then, the voltage of the input terminal INP further decreases and both VN51 and VN52 are reduced to be lower than VREF. Therefore, the comparator CMP301 outputs a low level and the AND circuit AND301 outputs a low level as the control signal SL1. As described so far, even if the voltage difference Vin between the input terminals INP and INM after the time t2, i.e., the input voltage, satisfies the relationship of INP<INM, the voltage detection circuit 304 outputs a low level if the input voltage Vin is large, and outputs a high level if the input voltage Vin is small.

As described above, when the input voltage Vin decreases, the voltage detection circuit 304 can make the control signal SL1 be a high level from a low level in a similar way as the frequency evaluation circuit 204 of the second exemplary embodiment. As mentioned above, since the operation of the selection circuit 203 that inputs the control signal output from the voltage detection circuit 304 is similar to the second exemplary embodiment, the explanation is omitted here.

As mentioned above, the integrator circuit 300 according to the third exemplary embodiment includes the chopping clock generation unit 320 that can vary the frequency of the chopping clock input to the differential amplifier circuit AMP1 according to the input voltage Vin. Therefore, as with the first and second exemplary embodiments, the integrator circuit 300 according to the third exemplary embodiment reduces the frequency of the chopping clock to suppress the deviation of the integration time from the ideal integration time Δt0 (with no offset). Conversely, if the input voltage Vin is high, the frequency of the chopping clock can be increased. Thus, as the frequency of the chopping clock can be varied according to the input voltage Vin, the number of chopping clocks can be an optimal value according to the input voltage Vin. Then, it is possible to suppress the deterioration of the offset error even at the time of inputting a low voltage.

The present invention is not limited to the above exemplary embodiments but can be modified as appropriate within the scope of the present invention. For example, the voltage input to the voltage detection circuit 304 may be the voltage of the input terminal INM since a decrease and increase in the input voltage Vin, which is a potential difference between the input terminals INP and INM, should be detected. However, the voltage of the input terminal INP shall be constant.

While the invention has been described in terms of several exemplary embodiments, those skilled in the art will recognize that the invention can be practiced with various modifications within the spirit and scope of the appended claims and the invention is not limited to the examples described above.

Further, the scope of the claims is not limited by the exemplary embodiments described above.

Furthermore, it is noted that, Applicant's intent is to encompass equivalents of all claim elements, even if amended later during prosecution.

The first to third exemplary embodiments can be combined as desirable by one of ordinary skill in the art.

What is claimed is:

1. An integration circuit comprising:
a first differential amplifier that reduces an input offset using a first clock signal as a clock signal for chopping, the input offset being an offset of a threshold voltage of a transistor that composes a differential pair;
a first and a second input terminals that are connected to an inverting input terminal and a noninverting input terminal of the first differential amplifier circuit; and
a first capacitance that is connected between the inverting input terminal of the first differential amplifier circuit and an output terminal of the first differential amplifier circuit,
wherein the integration circuit changes a frequency of the first clock signal input to the first differential amplifier circuit according to a potential difference between the first and the second input terminals.

2. The integration circuit according to claim 1, wherein when the potential difference between the first and the second input terminals decreases, the frequency of the first clock signal is reduced, and when the potential difference between the first and the second input terminals increases, the frequency of the first signal is increased.

3. The integration circuit according to claim 2, further comprising a first chopping clock control unit that varies the frequency of the first clock signal according to the potential difference between the first and the second input terminals, the first clock signal being input to the first differential amplifier circuit, wherein
the first chopping clock control unit comprises a first polarity selector switch, a second differential amplifier, a second capacitance, and a first clock generation unit,
the first polarity selector switch alternately switches a connection of the first and the second input terminals, and the inverting input terminal and the noninverting input terminal of the second differential amplifier according to a first control clock signal,
the second capacitance is connected between the inverting input terminal of the second differential amplifier circuit and an output terminal of the second differential amplifier circuit,
the second differential amplifier outputs a first integration voltage according to a potential difference input to the inverting input terminal and the noninverting input terminal, and
the first clock generation unit generates the first control clock and the first clock signal according to the first integration voltage.

4. The integration circuit according to claim 3, wherein
the first chopping clock control unit comprises a first window comparator,
when the first integration voltage output from the second differential amplifier is a first voltage or a second voltage, which has a predetermined potential difference from the first voltage, the first window comparator outputs a detection result, and
the first clock generation unit generates the first control clock signal according to the detection result output from the first window comparator.

5. The integration circuit according to claim 4, wherein
the first window comparator comprises a first and a second comparators,
the first comparator compares the first voltage and the first integration voltage and outputs a result as a first comparison result,
the second comparator compares the second voltage and the first integration voltage and outputs a result as a second comparison result,
the first clock generation unit comprises a first RS latch circuit, and
the first RS latch circuit outputs the first control clock signal according to the first and the second comparison results.

6. The integration circuit according to claim 2, further comprising a second chopping clock control unit that varies the frequency of the first clock signal according to the potential difference between the first and the second input terminals, the first clock signal being input to the first differential amplifier circuit, wherein
the second chopping clock control unit comprises a first and a second oscillators, a first selection circuit, and a first frequency evaluation circuit,
the second oscillator outputs a clock signal with a frequency lower than the first oscillator,
the first selection circuit selects one of an output clock signal from the first oscillator and an output clock signal from the second oscillator according to a first selection control signal and outputs the selected output clock signal as the first clock signal,
when a frequency of the second clock signal including a frequency according to the potential difference between the first and the second input terminals reaches a predetermined value, the first frequency evaluation circuit outputs the first selection control signal.

7. The integration circuit according to claim 6, wherein
the first frequency evaluation circuit comprises a third oscillator, and
when a difference between the frequency of the second clock signal and a frequency of the third oscillator reaches a predetermined difference, the first selection control signal is output

8. The integration circuit according to claim 6, wherein
the second chopping clock control unit comprises a voltage frequency conversion circuit, and
the voltage frequency conversion circuit outputs the second clock signal with a frequency according to the potential difference between the first and the second input terminals.

9. The integration circuit according to claim 2, wherein
the integration circuit comprises a second polarity selector switch and a third chopping clock control unit,
the second polarity selector switch alternately switches a connection of the first and the second input terminals, and the inverting input terminal and the noninverting input terminal of the second differential amplifier according to a second control clock signal,
the first differential amplifier outputs a second integration voltage according to the potential difference input to the inverting input terminal and the noninverting input terminal, and
the third chopping clock control unit generates the second control clock signal and the first clock signal according to the second integration voltage.

10. The integration circuit according to claim 9, wherein
the third chopping clock control unit comprises a second window comparator, a second clock generation unit, and a chopping clock control circuit,
when the second integration voltage output from the first differential amplifier is a third voltage or a second voltage, which has a predetermined potential difference from the third voltage, the second window comparator outputs a detection result,
the second clock generation unit generates the second control clock signal according to the detection result output from the second window comparator, and
the chopping clock control circuit generates the first control clock signal according to the second control clock signal.

11. The integration circuit according to claim 10, wherein
the second window comparator comprises a third and a fourth comparators,
the third comparator compares the third voltage and the second integration voltage and outputs a result as a third comparison result,
the fourth comparator compares the fourth voltage and the second integration voltage and outputs a result as a fourth comparison result,
the second clock generation unit comprises a second RS latch circuit, and
the second RS latch circuit outputs the second control clock signal according to the third and the fourth comparison results.

12. The integration circuit according to claim 2, wherein
the chopping clock control circuit comprises a fourth and a fifth oscillators, a second selection circuit, and a second frequency evaluation circuit,
the fourth oscillator outputs a clock signal with a frequency lower than the fifth oscillator,
the second selection circuit selects one of an output clock signal from the fourth oscillator and an output clock signal from the fifth oscillator according to a second selection control signal as the first clock signal, and
when the frequency of the second control clock signal reaches a predetermined value, the frequency evaluation circuit outputs the second selection control signal.

13. The integration circuit according to claim 12, wherein
the second frequency evaluation circuit comprises a sixth oscillator, and
when a difference between the frequency of the second control clock signal and a frequency of the sixth oscillator reaches a predetermined difference, the first selection control signal is output.

14. The integration circuit according to claim 2, further comprising a fourth chopping clock control unit that varies the frequency of the first clock signal, the first clock signal being input to the first differential amplifier circuit, wherein
the fourth chopping clock control unit comprises a seventh and an eighth oscillators, a third selection circuit, and a voltage evaluation unit,
the seventh oscillator outputs a clock signal with a frequency lower than the eighth oscillator,
the third selection circuit selects one of an output clock signal from the seventh oscillator and an output clock signal from the eighth oscillator according to a third selection control signal, and outputs the selected output clock signal as the first clock signal, and
the voltage evaluation circuit compares one of voltages of the first and the second input terminals with a reference voltage and outputs the third selection control signal according to the comparison result.
